(19) United States
(12) Patent Application Publication
(10) Pub. No.: US 2009/0104408 A1
(43) Pub. Date: Apr. 23, 2009

(54) Polyurea Coating Containing an Aggregate

(76) Inventor: Richard Albert Toman, Kirkwood, MO (US)

Correspondence Address: HARNESS, DICKEY, & PIERCE, P.L.C, 7700 Bonhomme, Suite 400, ST. LOUIS, MO, 63105, US

(21) Appl. No.: 12/254,477

(22) Filed: Oct. 20, 2008

Related U.S. Application Data
(63) Continuation of application No. 10/969,691, filed on Oct. 20, 2004, now abandoned.

(51) Int. Cl. B32B 5/16; C08L 75/02; B05D 1/36

(52) U.S. Cl. 428/143; 524/589; 427/403

(57) ABSTRACT

A coating or traffic bearing surface having a slow-set polyurea and an aggregate embedded throughout the polyurea.

### CROSS-REFERENCE TO RELATED APPLICATION

This application is a continuation of U.S. patent application Ser. No. 10/969,691 filed Oct. 20, 2004, the entire disclosure of which is incorporated herein by reference.

### FIELD

The present disclosure relates to coatings containing aggregates and, more specifically, a polyurea coating containing aggregate.

### BACKGROUND

Various coatings have been used to cover surfaces on roads, bridges, boat decks, floors, etc. to improve resistance to wear and deterioration. Typical surface coatings can include a resin-based binding medium comprising a two-part liquid polymer and hardener, which can be mixed and dispensed onto a concrete, metal or other support surfaces. One such coating is a polyurea that typically is a polyether-amines polyol elastomer. Polyurea resin-based binders have been used in combination with other reinforcing ingredients, such as aggregate, to provide an abrasion resistant coating for surfaces exposed to wear and traffic. Such products have been provided by pouring or spraying the polyurea onto a surface and broadcasting an aggregate onto the top of the polyurea coating. One characteristic of this type of polyurea coating is the rapid cure time of the coating, which is often under one minute. Such rapid cure times are often advantageous for resurfacing bridges and piers.

### SUMMARY

The present inventor has designed a coating having improved structural reinforcement and resistance to wearing.

According to one aspect of the present disclosure, a traffic bearing surface has a slow-set polyurea and an aggregate embedded throughout.

According to another aspect of the present disclosure, a coating includes a slow-set polyurea on a surface of a supporting structure. The slow-set polyurea forms a polyurea layer having a top surface, a middle portion, and a bottom surface with the bottom surface in contact with the surface of the supporting structure. An aggregate is substantially embedded between the top surface and the bottom surface and throughout the middle portion of the polyurea layer.

According to yet another aspect of the present disclosure, a method of forming a coating includes applying a slow-set polyurea layer onto a surface of a supporting structure and broadcasting an aggregate onto the polyurea layer. The broadcasted aggregate settles into the slow-set polyurea to embed the aggregate throughout the polyurea coating prior to a setting of the slow-set polyurea.

Further aspects of the present disclosure will be in part apparent and in part pointed out in the detailed description provided hereinafter. It should be understood that the detailed description and specific examples, while indicating certain preferred embodiments, are intended for purposes of illustration only and are not intended to limit the scope of this disclosure.

### BRIEF DESCRIPTION OF THE DRAWINGS

FIG. 1 is a side elevation view of a cross-section of a polyurea layer and a layer of aggregate broadcast on top of the polyurea layer in accordance with one embodiment of this disclosure.

FIG. 2 is a side elevation view of a cross-section of a coating illustrating the process of embedding aggregate in the coating in accordance with another embodiment of this disclosure.

FIG. 3 is a side elevation view of a cross-section of a coating with embedded aggregate according to another embodiment of this disclosure.

FIG. 4 is a side elevation view of a cross-section of a coating having a first layer of polyurea having embedded aggregate throughout and a second layer of polyurea having embedded aggregate throughout according to another embodiment of this disclosure.

FIG. 5 is a side elevation view of a cross-section of a coating having a top layer of polyurea covering a first layer of polyurea having embedded aggregate throughout according to another embodiment of this disclosure.

Corresponding reference characters indicate corresponding elements throughout the several views of the drawings. The following description of exemplary embodiments is merely exemplary in nature and is not intended to limit the various embodiments of this disclosure, their applications, or their uses.

### DETAILED DESCRIPTION OF EXEMPLARY EMBODIMENTS

A method of forming a coating, according to one embodiment of this disclosure, includes applying a slow-set polyurea layer onto a surface of a supporting structure and broadcasting an aggregate onto the polyurea layer. The broadcasted aggregate settles into the slow-set polyurea to embed the aggregate throughout the polyurea coating prior to a setting of the slow-set polyurea.

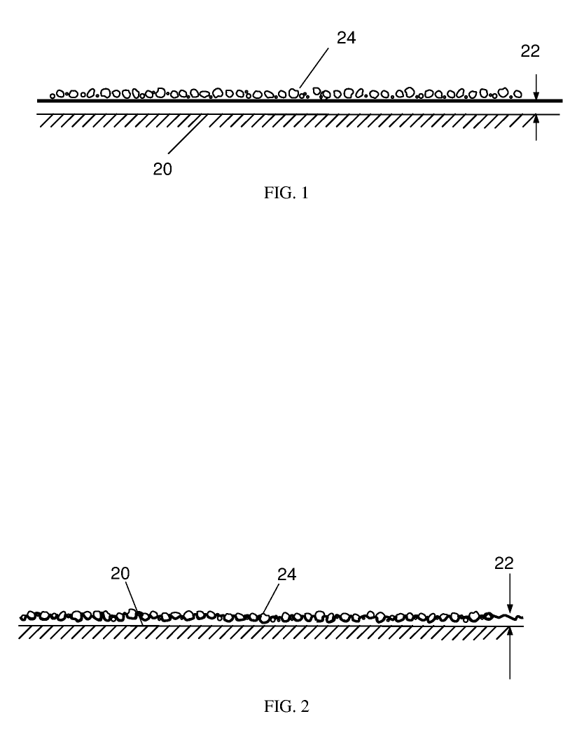

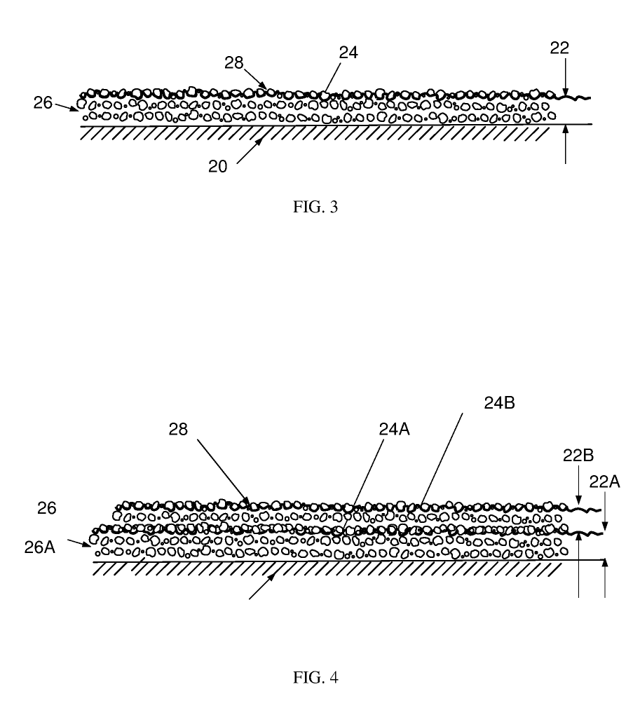

Referring to FIG. 1, a slow-set polyurea coating 22 is shown as having been applied to a supporting structure 20. The polyurea 22 can be a slow-set polyether-amines polyol resin composition. Aggregate 24 is applied to the surface of the polyurea coating 22. The aggregate 24 can be applied by a variety of methods including broadcast via a machine or manually by a user. As shown in FIG. 2, the aggregate 24 begins to settle and becomes at least partially embedded in the slow-set polyurea 22. Referring now to FIG. 3, the aggregate 24 becomes embedded throughout the polyurea coating 22 prior to its setting or becoming otherwise firm. Additional aggregate 24 can be applied during the process to provide sufficient quantities of the aggregate 24 to fill the polyurea 22 with the aggregate 24 throughout prior to the polyurea setting. As illustrated in FIG. 3, the aggregate 24 is embedded throughout the polyurea 22 and includes portions 26 that are not exposed above a surface of the polyurea 22 and portions 28 that are exposed above the surface of the polyurea 22. After the polyurea 22 sets, any excess or non-embedded aggregate (not shown) can be cleared or cleaned from the surface such that the partially exposed aggregate 28 and the polyurea combine to form a visible top surface of the coating. Such surface cleaning can include sweeping or vacuuming away the loose or non-embedded excess aggregate.

Referring again to FIG. 3, in one exemplary embodiment of this disclosure, a traffic bearing surface has a slow-set polyurea and an aggregate embedded throughout. The polyurea 22 having a top surface, a middle portion, and a bottom surface (as illustrated). The bottom surface of the polyurea is in contact with a surface of the supporting structure 20. The aggregate 24 is embedded throughout the polyurea 22 and can include embedded non-exposed aggregate 26 or exposed aggregate 28.

In some embodiments of this disclosure, the slow-set polyurea 22 is a resin-based product available under the name polyurea, available from Pacific Polymers International, Inc. of Garden Grove, Calif., or from Specialty Products Inc. of Lakewood, Wash. Other sources of polyurea 22 include members of the Polyurea Development Association (PDA), an international organization located in Kansas City, Mo., U.S.A. While slow-set polyurea compositions are generally known, the inventor hereof has developed a method of forming a coating and/or traffic bearing surface from the slow-set polyurea with an aggregate embedded throughout the polyurea that was heretofore unknown. As such, the coating produced in accordance with the principles of this disclosure has improved properties for coatings and traffic bearing surfaces.

The slow-set polyurea 22 typically has a cure time equal to or greater than one minute and preferably has a cure time in the range from one to twenty minutes. The selection of the polyurea 22 can be a function of its cure time. The desired cure time can be a function of a thickness of the applied polyurea layer; the composition of the aggregate 24; the temperatures of the polyurea, the supporting structure, and/or the ambient environment; the surface area for which the coating is to be applied; and the available resources for applying the aggregate to the polyurea. In one preferred embodiment, the cure time of the applied polyurea 22 is equal to or greater than five minutes. In another preferred embodiment, the cure time is equal to or greater than 10 minutes.

The slow-set polyurea polymer is generally prepared by pre-mixing each of the two parts of the polyurea 22 before combining and mixing the parts in pre-determined portions using a power mixer or other device that adequately mixes the two parts that comprises the final combination. The polyurea 22 can be heated to a temperature above the ambient temperature or can be combined and applied at the ambient temperature of the application or the temperature of the supporting structure 20. In some embodiments, heating of one or both parts of the polyurea mixture during pre-mixing provides improved application of the polyurea 22 to the supporting structure 20.

The slow-set polyurea 22 can be applied to a surface of the supporting structure 20 by pumping the resin and distributing the resin across the supporting structure 20 to obtain a desired predetermined wet-mil thickness for the polyurea 22 containing the aggregate 24. A variety of methods or devices for distributing the polyurea 22 can be used including a sprayer, a roller, a brush, a squeegee, or other spreading apparatus.

By way of example, to obtain a 250 millimeter (mils) or one-fourth (¼) inch coating, the slow-set polyurea 22 of about 125 to 150 mils coating can be applied to the surface of the supporting structure 20. The aggregate 24 is applied to the polyurea 22 and once embedded throughout the polyurea 22 results in a coating thickness of about 250 mils. The predetermined wet-mil thickness in one embodiment is in the range of about one-eighth (⅛) of an inch to about one-half (½) of an inch, but can alternatively be any thickness suitable for producing a uniform cross-section of aggregate within the coating. Such thickness can be a function of a size of the aggregate and the desired texture and structure of the fully embedded coating. Additionally, as discussed above a plurality of layers of the polyurea 22 and the aggregate 24 and/or a finish coat 30 provides for a total coating having various thicknesses.

The aggregate 24 can be any known aggregate material, including natural or synthetic materials. For example, the aggregate 24 can be rock, silica/sand, industrial byproducts, recycled products, glass, carbon, or metal. Additionally, other compounds or material can also be added to the polyurea and aggregate composition as desired for a particular coating application. For example, the coating can include fire retardants, accelerators, plasticizers, and coupling agents.

The coating can be formed by broadcasting an excess amount of the aggregate 24 across the top of the polyurea 22 while the polyurea is uncured. The aggregate 24 that has been broadcasted or distributed across the surface of the wet polyurea 22 is allowed to settle or is manually forced into the polyurea 22 to substantially embed into the middle portion of the polyurea 22, which envelopes and weeps around the many particles of the aggregate 24. However, often one or more “wet spots” can be visually identified on the top surface of the polyurea 22 and the aggregate 24. In such cases, additional aggregate 24 can be selectively applied or broadcast to portions of the top surface where these “wet spots” occur. The aggregate 24 can be broadcast in an excess amount across the surface of the polyurea 22 to the point of rejection from the polyurea 22 such that the polyurea surface no longer creates “wet spots.” In some embodiments, the aggregate 24 is throughout the polyurea 22 such as to provide a substantially uniform consistency of the aggregate 24 throughout the polyurea 22. The aggregate 24 can also be applied and forced into the polyurea 22 to provide for manual settling of the aggregate 24 throughout the polyurea 22.

The supporting structure 20 can be any type of structure including a concrete or asphalt surface on a road or bridge, or floor of a building, or can also comprise iron, steel, or masonite surface on the bridge, deck of a boat or pier. The supporting structure 20 can further include a traffic bearing surface such as a road surface, a bridge surface, a structural beam, a support structure, a parking deck, a road ramp, a walking ramp, a sidewalk, a driveway, a railway crossing, an airport runway, a pier, a masonite surface, a pool lining, a deck, a floor, and a patio. Additionally, the supporting structure 20 can be a first cured polyurea coating containing an aggregate and/or multiple layers of polyurea alone or in combination with an aggregate. The coating can be applied to any of a variety of surfaces for a broad range of applications and is not generally limited. The supporting structure 20 is preferably cleaned of any dirt, oil, water and other foreign debris before applying the first polyurea 22 of the coating to improve adherence of the coating to the supporting structure 20.

A coating can have multiple layers of polyurea 22. For example, in FIG. 4 a first layer of polyurea 22A includes aggregate 24A with non-exposed aggregate 26A. A second layer of polyurea 22B having a second aggregate 24B and second non-exposed aggregate 26B is layered onto the first layer of polyurea 22A. In such cases, the top layer can include the exposed embedded aggregate 28. One or more additional layers can also be added or layered onto the first and second layers to obtain a desired surface coating thickness.

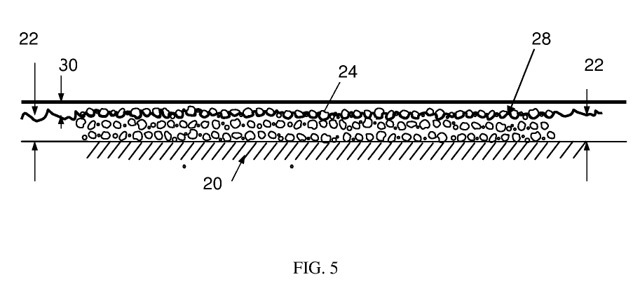

In the exemplary embodiment of FIG. 5, a finish layer 30 is applied to the top surface of the polyurea 22 containing the embedded aggregate 24. The finish layer 30 can be any material and in one preferred embodiment is a polyurea, such as a fast set polyurea. A fast set polyurea typically has a set time of less than one minute.

A coating and/or traffic bearing surface according to the various embodiments of this disclosure provides for a uniform reinforced coating with improved wear and deterioration properties. The coating can be produced by applying a pre-determined wet-mil thickness of a slow-set polyurea elastomer to a surface. In some embodiments, the application of more than one layer can also provide optimum durability of the coating throughout the life of the coating as it wears down over long periods of use.

When introducing aspects of this disclosure or embodiments thereof, the articles “a”, “an”, “the”, and “said” are intended to mean that there are one or more of the elements. The terms “comprising”, “including”, and “having” are intended to be inclusive and mean that there can be additional elements other than the listed elements.

In view of the above, it will be seen that several aspects of this disclosure are achieved and other advantageous results attained. As various changes could be made in the above exemplary constructions and methods without departing from the scope of this disclosure, it is intended that all matter contained in the above description or shown in the accompanying drawings shall be interpreted as illustrative and not in a limiting sense.

1. A traffic bearing surface comprising a slow-set polyurea and an aggregate embedded throughout the slow-set polyurea.

2-6. (canceled)

7. The traffic bearing surface of claim 1, further comprising a top layer of a polyurea covering the slow-set polyurea containing the embedded aggregate.

8. (canceled)

9. A coating comprising a slow-set polyurea on a surface of a supporting structure, said slow-set polyurea forming a polyurea layer having a top surface, a middle portion, and a bottom surface, said bottom surface of the polyurea being in contact with the surface of the supporting structure; and an aggregate substantially embedded between the top surface and the bottom surface and throughout the middle portion of the polyurea layer.

10. The coating of claim 9 wherein the polyurea layer has a thickness of between about one-eighth of an inch and about one-half of an inch.

11. The coating of claim 9 wherein the aggregate is fully embedded in the slow-set polyurea.

12. The coating of claim 9 wherein the aggregate is embedded in the slow-set polyurea in a substantially uniform consistency throughout the polyurea layer.

13. The coating of claim 9, further comprising a top layer of a polyurea covering the slow-set polyurea containing the embedded aggregate.

14. The coating of claim 9 wherein the top layer of polyurea is a fast set polyurea.

15. A method of forming a coating containing an aggregate, the method comprising:
applying a slow-set polyurea layer onto a surface of a supporting structure; and
broadcasting an aggregate onto the polyurea layer, said broadcasted aggregate settling into the slow-set polyurea to embed the aggregate throughout the polyurea coating prior to a setting of the slow-set polyurea.

16. The method of claim 15 wherein applying a slow-set polyurea is at least one of spraying, pumping and spreading.

17. The method of claim 15 wherein applying the slow-set polyurea produces a polyurea layer having a thickness of between about one-eighth of an inch and about one-half of an inch.

18. The method of claim 15 wherein the aggregate settles into the slow-set polyurea to become embedded in the slow-set polyurea having a uniform consistency throughout the slow-set polyurea.

19. The method of claim 15 wherein the applying of the slow-set polyurea includes applying the slow-set polyurea when the slow-set polyurea is at an ambient temperature.

20. The method of claim 15 wherein the applying of the slow-set polyurea includes applying the slow-set polyurea when the slow-set polyurea is a temperature greater than an ambient temperature.

21. The method of claim 15 wherein the slow-set polyurea has a set time of greater than about five minutes

22. The method of claim 15 wherein the slow-set polyurea has a set time of greater than about ten minutes.

23. The method of claim 15, further comprising applying additional aggregate after broadcasting to a select portion of the top surface of the polyurea layer.

24. The method of claim 15, further comprising applying a second layer of a polyurea onto the polyurea layer containing the aggregate.

25. The method of claim 24 wherein applying the top layer follows a setting of the slow-set polyurea containing the aggregate.

26. A coating produced according to the method of claim 15.
